(19) United States
(12) Patent Application Publication
(10) Pub. No.: US 2007/0150177 A1
(43) Pub. Date: Jun. 28, 2007

(54) Automated method to ensure network route diversity

(75) Inventors: Elizabeth D. Smith, San Diego, CA (US); Charles G. Esser, Pewaukee, WI (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/317,007

(22) Filed: Dec. 27, 2005

(51) Int. Cl. G01C 21/32

(52) U.S. Cl. 701/202; 701/209; 340/995.19

(57) ABSTRACT

Routing diversity is evaluated. Utility line route mapping coordinates are obtained for a first utility line route and a second utility line route. At least one utility line route mapping coordinate of the first utility line route is compared with at least one utility line route mapping coordinate of the second utility line route, to obtain at least one comparison result. The at least one comparison result is evaluated for route diversity.

### BACKGROUND OF THE DISCLOSURE

1. Field of the Disclosure

The present disclosure relates to network diversity. More particularly, the present disclosure relates to identifying network routes and determining whether the identified network routes are diverse.

2. Background Information

Disruptions to utility services and transportation on a regional or even national level can be caused by natural disasters, accidents, equipment malfunctions, power outages, terrorist incidents and similar events. To reduce the potential for disruption resulting from an isolated incident, diversity is often desired when planning alternate routes or paths for such utility services and transportation. For example, a customer wishing to ensure the availability of back-up (secondary) utility lines may require that the back-up utility lines do not run across the same geographical features (e.g., bridges, buildings, cities or regions) as primary utility lines, so as to reduce the possibility that both primary and secondary utility lines will be taken out of service in a single isolated incident.

Validation of diversity is typically done manually, using information provided on an as-needed basis from, for example, telecommunications carriers. As an example, an engineer may use online maps and best guess comparisons to compare proposed service routes for diversity.

The results of such comparisons using online local maps are often not considered reliable for urban areas due to, for example, the level of irrelevant detail shown on such maps. Additionally, the results of such comparisons using online long distance maps are often not considered reliable for regional or national areas due to, for example, the lack of relevant detail shown on such maps. As a result, it may be time consuming to compare proposed routes through urban areas, whereas it may be difficult to accurately compare propose routes over long distances. As an example of a problem that might occur comparing proposed routes over long distances, it may be difficult to determine whether a route follows a railroad track or an interstate highway as much as one-half mile or more from the railroad track.

As described above, diversity is typically documented manually using hand drawn diagrams or maps copied from the internet. Imprecise lines are overlapped on the diagrams or maps using computerized graphics tools. However, diversity verification is labor intensive and unreliable, and suffers from too much irrelevant detail and/or too little relevant and accurate detail.

### BRIEF DESCRIPTION OF THE DRAWINGS

The present disclosure is further described in the detailed description that follows, by reference to the noted drawings by way of non-limiting examples of embodiments of the present disclosure, in which like reference numerals represent similar parts throughout several views of the drawing, and in which:

FIG. 1 shows an exemplary general computer system that includes a set of instructions for ensuring network route diversity;

FIG. 2 shows an exemplary system for obtaining route map information;

FIG. 3 shows an exemplary route map for which route map information is obtained;

FIG. 4 shows another exemplary route map for which route map information is obtained;

FIG. 5 shows another exemplary route map for which route map information is obtained;

FIG. 6 shows an exemplary method for creating a route map;

FIG. 7 shows an exemplary method for evaluating route map diversity;

FIG. 8 shows an exemplary system for evaluating route map diversity; and

FIG. 9 shows an exemplary graphical user interface for retrieving maps and evaluating route map diversity.

### DETAILED DESCRIPTION

In view of the foregoing, the present disclosure, through one or more of its various aspects, embodiments and/or specific features or sub-components, is thus intended to bring out one or more of the advantages as specifically noted below.

Map diagrams may be used to determine whether diversity exists for proposed alternative routes. Such diagrams can be provided to customers, in response to requests for proposals from customers, and used to provide reference information for engineering and operational research. Diversity is determined by comparing coordinates or other geographic data for individual points on the routes depicted on the maps. The results of the comparison are judged against diversity parameters which are either predetermined or individually selected by a user.

According to an aspect of the present disclosure, a computer-implemented method is provided for evaluating routing diversity. The method includes obtaining utility line route mapping coordinates for a first utility line route and a second utility line route. The method also includes comparing at least one utility line route mapping coordinate of the first utility line route with at least one utility line route mapping coordinate of the second utility line route, to obtain at least one comparison result. The method further includes evaluating the at least one comparison result for route diversity.

According to another aspect of the present disclosure, the evaluating includes determining whether the first utility line route and the second utility line route conform to predetermined route diversity parameters.

According to still another aspect of the present disclosure, the computer-implemented method also includes comparing a comparison result of a set of utility line routes, which includes the first utility line route and the second utility line route, with a comparison result of another set of utility line routes to evaluate route diversity of the sets relative to each other.

According to yet another aspect of the present disclosure, the utility line routes delineate telecommunications system routes.

According to another aspect of the present disclosure, the method also includes selecting criteria for utility line route mapping coordinates to be obtained.

According to still another aspect of the present disclosure, the selecting includes entering criteria into fields on a graphical user interface.

According to yet another aspect of the present disclosure, the determining further includes comparing a minimum vertical distance between utility line routes through a single location.

According to another aspect of the present disclosure, the evaluating also includes determining a minimum distance between two of the utility routes.

According to still another aspect of the present disclosure, the computer-implemented method also includes selecting telecommunications carriers.

According to yet another aspect of the present disclosure, the obtaining include obtaining telecommunications line route mapping coordinates for telecommunications lines corresponding to the selected telecommunications carriers.

According to an aspect of the present disclosure, a computer readable medium is provided for storing a computer program that verifies routing diversity. The computer readable medium includes a mapping coordinates obtaining code segment that obtains utility line route mapping coordinates for a first utility line route and a second utility line route. The computer readable medium also includes a comparing code segment that compares at least one utility line route mapping coordinate of the first utility line route with at least one utility line route mapping coordinate of the second utility line route, to obtain at least one comparison result. The computer readable medium further includes a route diversity evaluating code segment that evaluates the at least one comparison result for route diversity.

According to another aspect of the present disclosure, the mapping coordinates include latitude and longitude coordinates obtained using a global positioning satellite (GPS) device.

According to still another aspect of the present disclosure, the utility line route mapping coordinates are used to display the utility line routes on a graphical user interface (GUI).

According to yet another aspect of the present disclosure, the utility line routes are superimposed on a map image on the graphical user interface.

According to another aspect of the present disclosure, a level of detail of the map image can be selected.

According to still another aspect of the present disclosure, the computer readable medium also includes a coordinate retrieving code segment that retrieves utility line route mapping coordinates from a database. The utility line routes are superimposed on a map image using the utility line route mapping coordinates.

According to yet another aspect of the present disclosure, the coordinates are associated with a geographical characteristic of terrain corresponding to the coordinates.

According to an aspect of the present disclosure, a computer system is provided. The computer system includes a retriever that obtains utility line route mapping coordinates for a first utility line route and a second utility line route. The computer system also includes a comparator that compares at least one utility line route mapping coordinate of the first utility line route with at least one utility line route mapping coordinate of the second utility line route, to obtain at least one comparison result. The computer system further includes an evaluator that evaluates the at least one comparison result for route diversity.

According to another aspect of the present disclosure, the computer system also includes a determiner that determines whether the first utility line route and the second utility line route conform to predetermined route diversity parameters.

According to still another aspect of the present disclosure, the route diversity parameters include a minimum vertical distance between at least two utility line routes when a latitude and longitude of the at least two utility line routes coincide.

According to yet another aspect of the present disclosure, the minimum vertical distance includes at least one underground component.

According to another aspect of the present disclosure, the route diversity parameters include a minimum distance between at least two utility line routes based on latitude and longitude coordinates of the at least two utility line routes.

According to still another aspect of the present disclosure, the evaluator is configured to evaluate whether the utility line routes each pass through a common address.

According to yet another aspect of the present disclosure, the evaluator is configured to evaluate whether the utility line routes each pass through at least one of a common floor, suite and room of a common address.

According to another aspect of the present disclosure, the evaluator is configured to evaluate whether utility line routes both pass through a common geographical region.

According to still another aspect of the present disclosure, the evaluator is configured to evaluate whether utility line routes both pass through a common network equipment node.

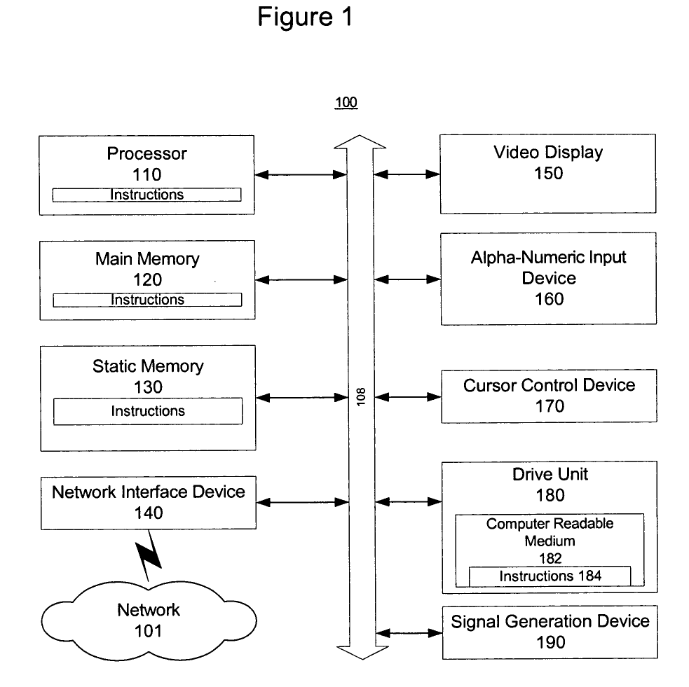

Referring to FIG. 1, an illustrative embodiment of a general computer system, on which an automated method to ensure network route diversity can be implemented, is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Using a general computer system as shown in FIG. 1, a user can obtain route maps and ensure route diversity for routes depicted on the route maps. Diversity can be verified using data associated with various points on the routes.

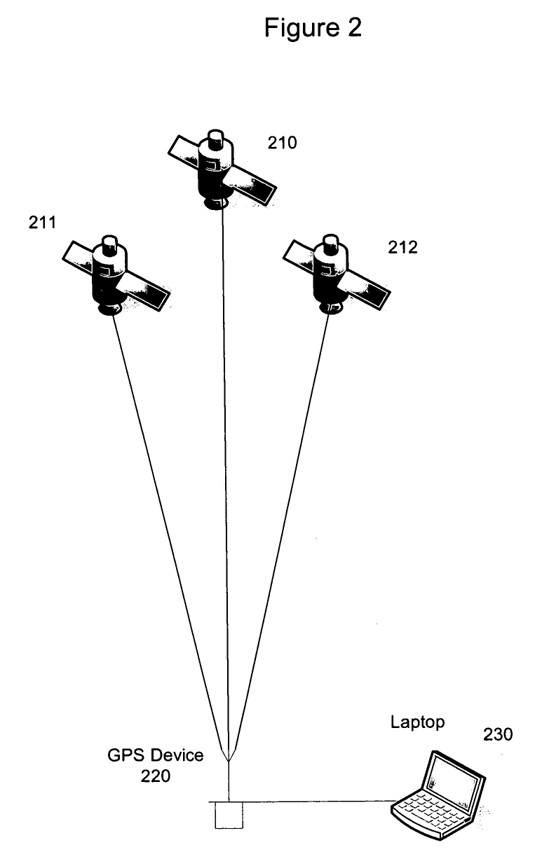

FIG. 2 shows an exemplary system for obtaining route map information. A global positioning satellite (GPS) device 220 receives synchronization signals from satellites 210-212. The synchronization signals are used by the GPS device 220 to obtain latitude and longitude coordinates of the location of the GPS device 220. In the embodiment of FIG. 2, a series of latitude and longitude coordinates corresponding to different locations (a route) of the GPS device are stored on a laptop 230. The latitude and longitude coordinates of various locations as stored on the laptop 230 are used to create a route map.

Of course, a laptop 230 is not required to receive coordinates from a GPS device 220. Rather, the GPS device 220 may itself store a series of coordinates. Further, any other type of mobile processing device may be used in association with the GPS device 220 to receive data. In an embodiment, a user may simply transcribe coordinate information for points on a route. In yet another embodiment, a user may relay coordinate information for points on a route over communications network, so that the map is created remotely using the coordinates obtained by the GPS device 220.

The laptop 230 or the GPS device 220 also stores other data used to describe the location and geography of various coordinates. This additional data may include, for example, a map or route name, an entity such as a telecommunications carrier corresponding to the route being depicted, line or equipment types associated with particular locations, and numerous geographic descriptors to describe particular locations.

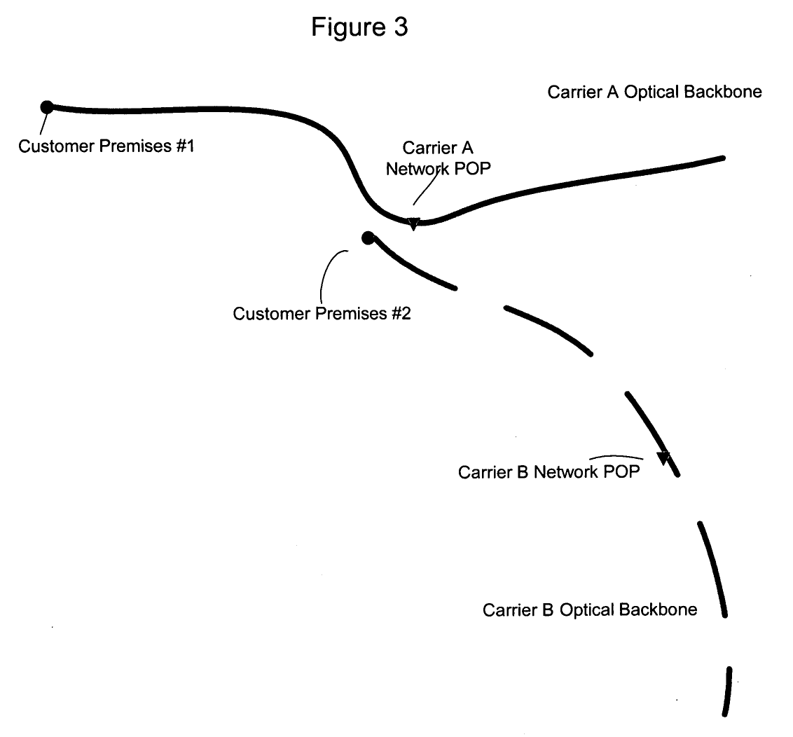

FIG. 3 shows an example route map for which route map information is obtained. As shown in FIG. 3, routes to customer premises #1 and #2 do not intersect with each other, and do not both intersect with the same geographical feature or network component. The routes are optical backbones for different carriers, and each includes a network point of presence (POP). In the example of FIG. 3, coordinate information may be obtained for various points along each route. In the embodiment of FIG. 3, coordinate information may be associated with information to describe that particular coordinates are for a customer premise or a point of presence.

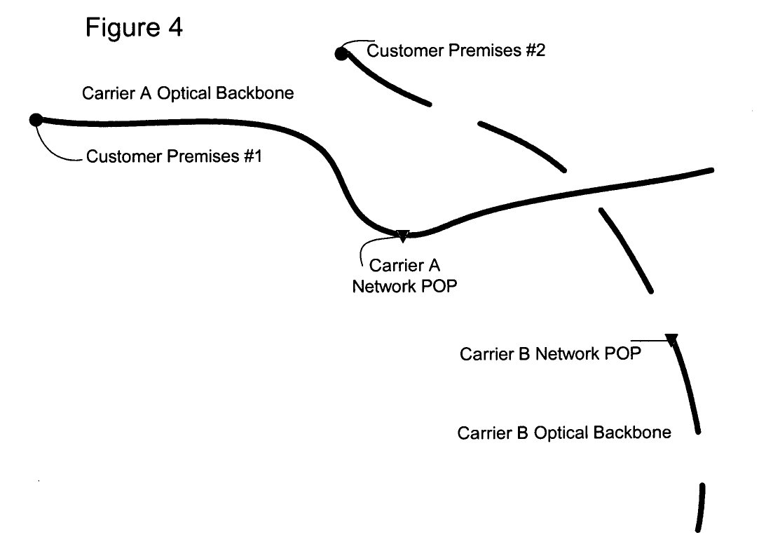

FIG. 4 shows another example of route map for which route map information is obtained. In the example of FIG. 4, routes are again optical backbones, and each includes a point of presence. The two routes shown in FIG. 4 intersect with each other on at least a horizontal plane when viewed from above.

In some cases, an end user may specify that two routes such as a primary and secondary route should never intersect, in which case the routes shown in FIG. 4 would be judged to lack diversity. In other cases, an end user may specify a minimum distance that must be maintained between any two points on alternate routes, in which case the routes shown in FIG. 4 would also be judged to lack diversity.

In other cases, route intersections may be tolerated under specified conditions, such as vertical diversity. For example, an end user may tolerate horizontal intersections so long as one route is a specified distance underground and the other route is above ground.

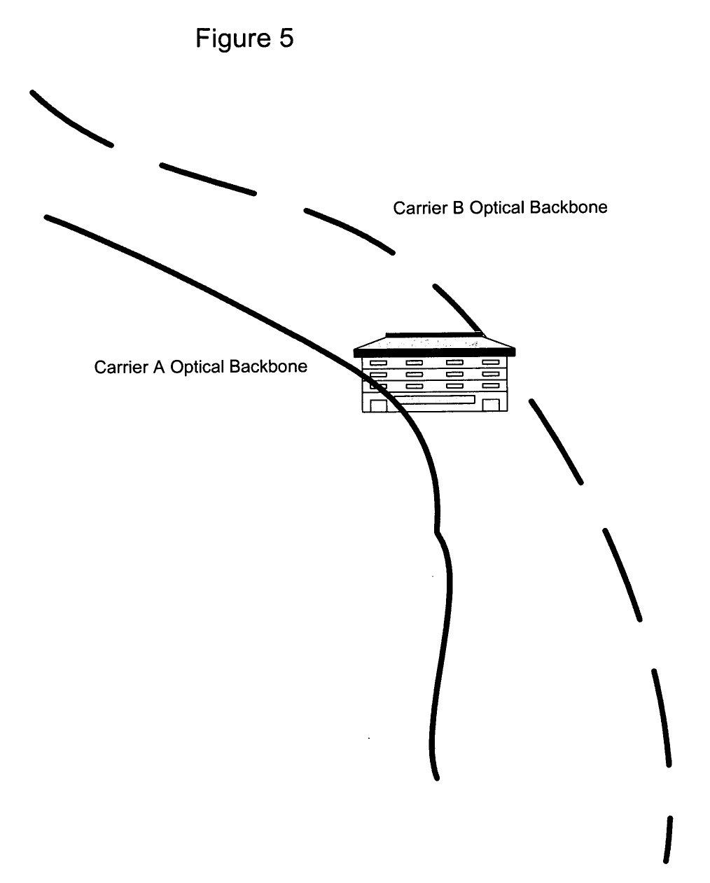

FIG. 5 shows another example of route map for which route map information is obtained. In the example shown in FIG. 5, two routes run close to or through the same building. An end user may specify that routes do not both traverse the same street address or geographic region (e.g., zip code, city, county, state), in which case the routes shown in FIG. 5 would be judged to lack diversity. Alternatively, an end user may specify that routes do not both traverse the same room or floor in a single building, in which the various rooms or floors in the building shown in FIG. 5 would have be compared to judge whether the routes shown in FIG. 5 lack diversity. Such restrictions may be required in cases of critical telecommunications hubs at a single location, where it would be difficult to find routes that does not travel through the single location.

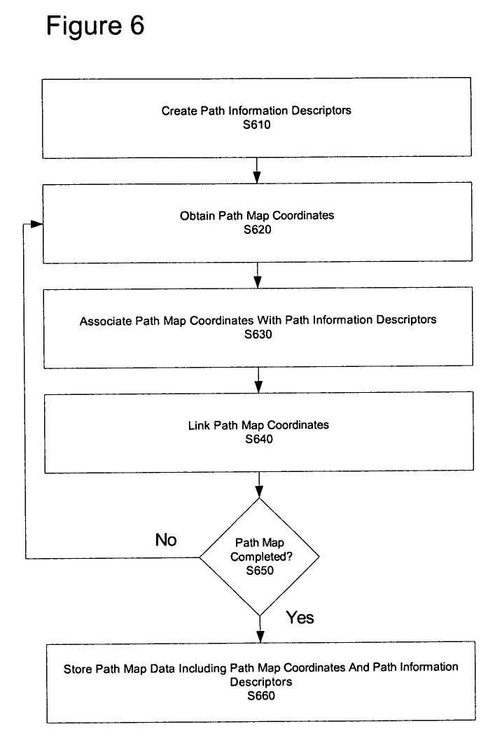

FIG. 6 shows an exemplary method for creating a route map. As shown, route information descriptors are created at S610 for a route map to be created. For example, the person creating the route map may create a document and title the document “Route Map 1”. In an embodiment, a software program enables a user to title each route before or while coordinates and route information are obtained. Route coordinates for the route map are obtained at S620. For example, the person creating the route map may use the GPS device 220 to obtain a series of horizontal coordinates (latitude and longitude) for the route map. Additionally, the person creating the route map may use the GPS device 220 to obtain or enter a vertical coordinate for a route being traced for a route map. In an embodiment, the vertical coordinate may indicate a distance by which a line is buried underground.

At S630, the route map coordinates are associated with the route information descriptors. For example, the route map coordinates may be stored in the document entitled “Route Map 1”. In an embodiment, the person creating the route may use a software program that tracks coordinates of the GPS device 220, so that route map coordinates are automatically associated with route information descriptors. For example, a user may select an option of “new route” before traveling a new route, and select an option of “end route” once the information for the route has been collected. In an embodiment, the route map is automatically displayed on the GPS device 220 or a device that receives the coordinate information from the GPS device 220.

The route map coordinates are linked together at S640. The route map coordinates may be linked according to, for example, the relative times at which they were obtained. The linking of route map coordinates is done by associating route map coordinates with each other and with route map information of the route map being created. For example, the route map coordinates may be stored in a document or folder together. Alternatively, the route map coordinates may be associated in a memory as being information of a single specified route map.

At S650, a determination is made as to whether a route map is completed. If the route map is not completed (S650 =No), the process returns to S620 and additional route map coordinates are obtained. The route map is completed when the user creating the route map indicates that the route map is completed by, for example, entering such information into the GPS device 220 or an associated device. When the route map is completed (S650 =Yes), the route map data is stored at S660. The stored route map data includes route map coordinates and route information descriptors.

The route information descriptors may include information that only applied to one or more specific set of coordinates for a route map (i.e., but not necessarily all the specific coordinates for a route map). For example, the information for a specific location may include geographical information such as a city name, a state name, a zip code name, a street address or a physical geographic descriptor for a particular location such as “Chicago River 18th Street Bridge”. Additionally, the information for a specific location may include a line type, a line component, and/or a type of equipment at a specific location. As noted above, information for a specific location may also include latitude or longitude, and/or a vertical height/depth of the line. In an embodiment, the information includes a floor, suite or room of a specific address through which the route passes. The information noted above as being stored for specific points on a route map is only exemplary, and any descriptive information may be stored for specific points of a route map within the scope and spirit of the present disclosure.

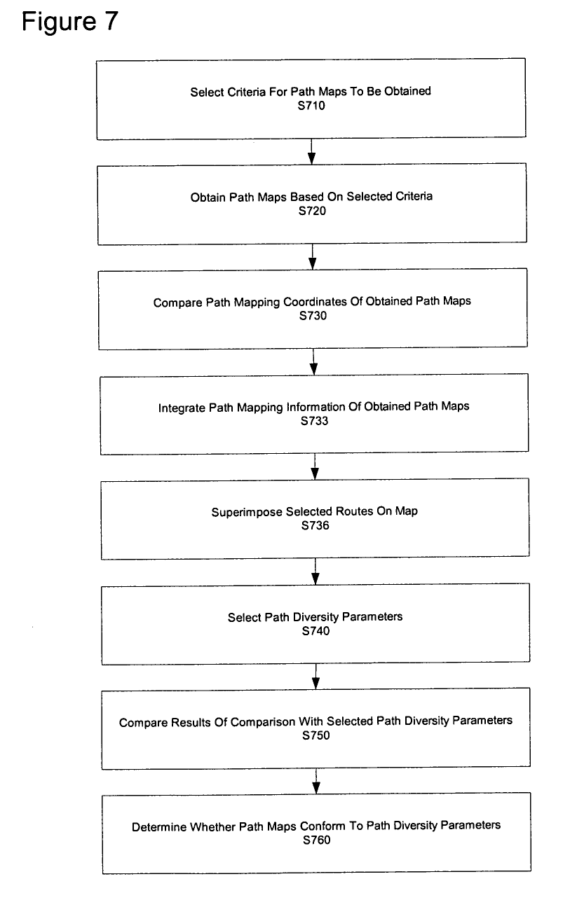

FIG. 7 shows an exemplary method for evaluating route map diversity. At S7 10, criteria are selected for the route maps to be obtained. For example, the criteria may be any descriptive information for specific points of a route map as described above. The route maps may be retrieved by name when the person searching for route maps knows the name of route maps to be retrieved. In an embodiment, the criteria used at S710 to retrieve route maps include a specified telecommunications carrier who provides one or more route maps to telecommunications service providers. For example, an employee of a telecommunications service provider may specify that maps for “carrier X” are to be retrieved. Of course, the criteria may include geographic information, equipment or line information, or any other information used to describe one or more points of the route map.

At S720, route maps are obtained based on the selected criteria. As an example, route maps may be retrieved from a database using a computer. Alternatively, route maps may be retrieved from a mobile memory such as a compact disc (CD) read only memory (ROM) or flash memory device.

At S730, route mapping information of different route maps are compared. The comparison may include numerous determinations, such as whether route maps intersect horizontally with each other, with a common address, with a common building, with a common piece of equipment (e.g., with a common network equipment node) on the routes, with a common city or geographic region, with a common landmark (e.g., the Chicago River 18th Street Bridge), or with an underground conduit.

At S733, the data of the different points on the retrieved routes is integrated to display the alternate routes on a single map image on a graphical user interface. For example, the horizontal coordinates of a first map route may be used to display the first map route on a map in red. The horizontal coordinates of a first map route may be used to display the second map route on a map in blue. Although not used for the horizontal display of map routes, other information such as vertical coordinates of each point may be associated with the different points on the map routes, and used in comparisons or displayed for the user upon command. At 736, the different routes are both displayed on the same map on a graphical user interface.

At S740, route diversity parameters are selected. For example, a route diversity parameter may be that no intersections occur, including intersections with the same geographical locations as described above. In an embodiment, a route diversity parameter may be that a minimum distance exists between any point on a first route and any point on a second route. For example, a customer may require that a minimum of 5 miles exists between any two points on two routes. At S750, the results of the route mapping coordinate comparison are compared with the selected route diversity parameters, and at S760 a determination is made as to whether the route maps being compared conform to the selected route diversity parameters.

Of course, the various processes of the embodiment shown in FIG. 7 may be performed in a different order or not at all. For example, route diversity parameters may be selected at S740 before comparing route map information at S730, so that fewer aspects of the route map information are compared at S730.

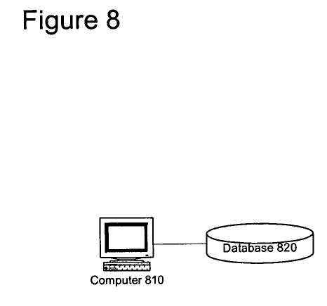

FIG. 8 shows an exemplary system for evaluating route map diversity. As shown in FIG. 8, the system for evaluating route map diversity includes a computer 810 and a database 820. The computer 810 may be connected to the database 820 over a communications network such as the internet. In an embodiment, the database 820 is secured such that only authorized users can obtain access to the database 820. The computer 810 retrieves selected route maps from the database 820. As described above, the user can use a program on the computer 810 to examine the route maps and ensure diversity in utility routes illustrated by the route maps.

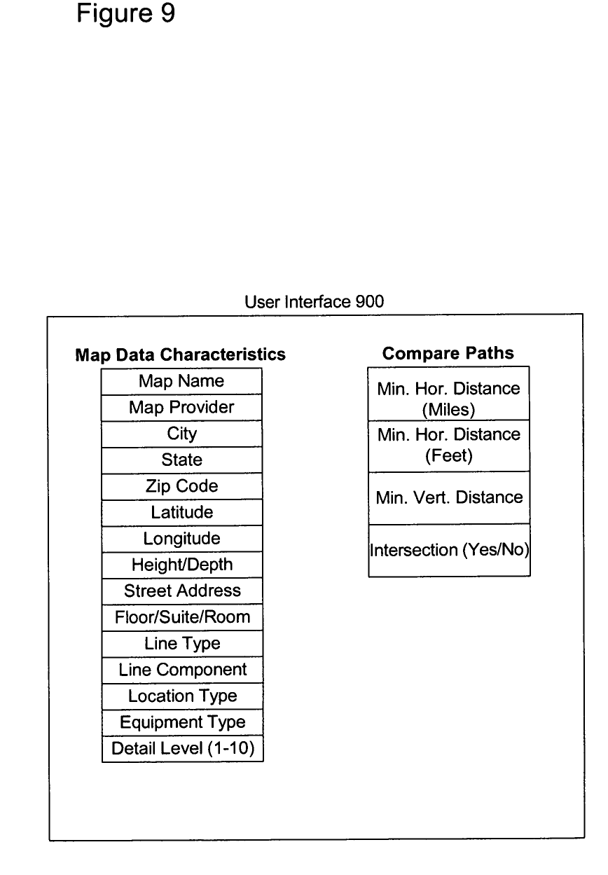

FIG. 9 shows an exemplary graphical user interface 900 used by a user to enter information for retrieving maps and evaluating route map diversity. As shown, a user may enter information into the column on the left side of the user interface 900 to search for maps in a memory. In the embodiment of FIG. 9, the user may enter a specific map name or the name of a map provider such as a telecommunications carrier. The user may also search maps for information related to the geographic data therein, such as a city, state, zip code, street address or any other recognizable reference information. The user may also search for specific latitudes and longitudes or a range of latitudes and longitudes, as well as height or depth of signal lines.

In the embodiment of FIG. 9, the user may search for a particular floor, suite or room of an individual address, such as when telecommunications lines run through a major telecommunications hub. The user may also search for particular line types, line components or equipment types such as the types of equipment that process signals carried on telecommunications lines. The user may also specify a desired level of detail such as 1 to 10 for viewing the maps to be retrieved.

As described above, latitudes and longitudes of the individual points are obtained using the GPS system 220. Each point on a map may be sequentially numbered (e.g., 1, 2, 3, 4 . . .) so that a user may specify a level of detail for viewing a particular point. Of course, the user may view a particular point on a route map using a mouse cursor to center the map on a graphical user interface (GUI). The user can then select the scope of detail to be shown on the map using an interactive control on the map display.

The latitudes and longitudes of individual points are associated to form a route on a map. Characteristics of the geography associated with the various points are entered and associated with the individual points. A completed route is stored as an individual map with the collected information related to the individual points.

When multiple maps are retrieved, the routes depicted thereon are compared, either using a predetermined set of comparisons or a particular set of comparisons selected by a user. A user may compare data of routes on two maps using fields in either the right column or the left column of the user interface 900. For example, software may be used to determine a minimum horizontal distance between any two points on two routes in miles or feet. Additionally, routes may be compared to determine whether horizontal intersections exist, and intersecting horizontal routes may be compared to determine a minimum vertical clearance at the point of intersection.

Of course, characteristics shown in the left column may also be used in the comparisons. For example, a comparison may be made to determine whether two routes intersect with the same city, state, zip code, or floor, suite or room of a particular street address. A comparison may also be made to determine whether an intersection occurs with the same type of location, such as an individual bridge over a river, or an individual underground vault. In other words, even when wires do not cross horizontally, they may run close to each other and parallel over, through or in a common geographic feature. Using the automated method to ensure network route diversity, routes can be compared for a variety of intersection-types, and redundancies can be automatically detected.

As described above, software may be used to determine whether utility routes are diverse. Alternatively, software may be used to determine whether transportation routes or any other type of routes are diverse. As an example, utility routes for which diversity is sought may be telecommunications network routes such as private line or ring topology.

Software may be used to reference a memory containing horizontal coordinates of available routes from the sources that provide the available routes. As an example, the available network routes may be stored in a secure database that can be accessed by authorized personnel over a communications system. In the example of telecommunications network routes, the sources of routes may include interexchange or local telecommunications providers. The memory that stores such routes may be loaded using computer aided drafting (CAD) mapping software that references network diagrams provided by underlying carriers.

Examples of route maps for which route map information is obtained are shown in FIGS. 3-5. For selected points along the route maps, reference information such as coordinates is obtained and provided to a user. As an example, a long distance network interexchange carrier could have vertical and horizontal coordinates loaded into a database.

Software can be used to provide an engineer an online screen to search for points of reference such as a city name or common language location identification (CLLI) code to define a routing scheme. A routing scheme may be defined by mid-point and end-point switches. Routing diversity software may be used initially to determine routes when numerous prospective routes are available.

An engineer may select types of diversity to validate. For example, an engineer may validate point of presence to point of presence (POP-to-POP), or serving wire center to serving wire center (SWC-to-SWC) diversity in a telecommunications network. The engineer could also ensure that a minimum distance (e.g., 10 feet) is maintained between routes, or that no two routes pass through the same building, or that any two routes having a location in common have diverse (different) entries and/or exits to and from the location.

An engineer may use the software to validate route diversity using maps from selected carriers. The software may be used to compare data of specified points along the identified route maps. The comparison results may be displayed to show whether diversity exists.

Accordingly, the automated method to ensure network route diversity may be used by utility providers, including telecommunications long-distance service providers, local exchange carriers (LECs), and other point-to-point network providers.

As described above, the automated method to ensure network route diversity can be used to ensure that alternate routes are diverse and not susceptible to failure resulting from the same isolated natural disaster, accident, equipment malfunction, power outage, terrorist incident or similar event. Accordingly, the software can be used to allow a telecommunications service provider to respond to requests for proposals (RFPs) quickly, with adequate and accurate information, and high confidence.

Although the present specification describes components and functions that may be implemented in particular embodiments with reference to particular standards and protocols, the disclosure is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present invention is to be determined by the broadest permissible interpretation of the following claims and their equivalents, and shall not be restricted or limited by the foregoing detailed description.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A computer-implemented method for evaluating routing diversity, the method comprising:
obtaining utility line route mapping coordinates for a first utility line route and a second utility line route;
comparing at least one utility line route mapping coordinate of the first utility line route with at least one utility line route mapping coordinate of the second utility line route, to obtain at least one comparison result; and
evaluating the at least one comparison result for route diversity.

2. The computer-implemented method for evaluating routing diversity of claim 1, the evaluating comprising:
determining whether the first utility line route and the second utility line route conform to predetermined route diversity parameters.

3. The computer-implemented method for evaluating routing diversity of claim 1, further comprising:
comparing a comparison result of a set of utility line routes, comprising the first utility line route and the second utility line route, with a comparison result of another set of utility line routes to evaluate route diversity of the sets relative to each other.

4. The computer-implemented method for evaluating routing diversity of claim 1, wherein the utility line routes delineate telecommunications system routes.

5. The computer-implemented method for evaluating routing diversity of claim 1, further comprising:
selecting criteria for utility line route mapping coordinates to be obtained.

6. The computer-implemented method for evaluating routing diversity of claim 5, the selecting comprising:
entering criteria into fields on a graphical user interface.

7. The computer-implemented method for evaluating routing diversity of claim 2, the determining further comprising:
comparing a minimum vertical distance between utility line routes through a single location.

8. The computer-implemented method for evaluating routing diversity of claim 1, the evaluating further comprising:
determining a minimum distance between the utility routes.

9. The computer-implemented method for evaluating routing diversity of claim 1, further comprising:
selecting telecommunications carriers.

10. The computer-implemented method for evaluating routing diversity of claim 9, the obtaining further comprising:
obtaining telecommunications line route mapping coordinates for telecommunications lines corresponding to the selected telecommunications carriers.

11. A computer readable medium for storing a computer program that verifies routing diversity, comprising:
a mapping coordinates obtaining code segment that obtains utility line route mapping coordinates for a first utility line route and a second utility line route;
a comparing code segment that compares at least one utility line route mapping coordinate of the first utility line route with at least one utility line route mapping coordinate of the second utility line route, to obtain at least one comparison result; and
a route diversity evaluating code segment that evaluates the at least one comparison result for route diversity.

12. The computer readable medium of claim 11, wherein the mapping coordinates comprise latitude and longitude coordinates obtained using a global positioning satellite (GPS) device.

13. The computer readable medium of claim 11, wherein the utility line route mapping coordinates are used to display the utility line routes on a graphical user interface (GUI).

14. The computer readable medium of claim 13, wherein the utility line routes are superimposed on a map image on the graphical user interface.

15. The computer readable medium of claim 14, wherein a level of detail of the map image can be selected.

16. The computer readable medium of claim 14, further comprising:
a coordinate retrieving code segment that retrieves utility line route mapping coordinates from a database,
wherein the utility line routes are superimposed on a map image using the utility line route mapping coordinates.

17. The computer readable medium of claim 12, wherein the coordinates are associated with a geographical characteristic of terrain corresponding to the coordinates.

18. A computer system, comprising:
a retriever that obtains utility line route mapping coordinates for a first utility line route and a second utility line route;
a comparator that compares at least one utility line route mapping coordinate of the first utility line route with at least one utility line route mapping coordinate of the second utility line route, to obtain at least one comparison result; and
an evaluator that evaluates the at least one comparison result for route diversity.

19. The computer system of claim 18, further comprising:
a determiner that determines whether the first utility line route and the second utility line route conform to predetermined route diversity parameters.

20. The computer system of claim 19,
wherein the route diversity parameters comprise a minimum vertical distance between at least two utility line routes when a latitude and longitude of the at least two utility line routes coincide.

21. The computer system of claim 20,
wherein the minimum vertical distance includes at least one underground component.

22. The computer system of claim 19,
wherein the route diversity parameters comprise a minimum distance between at least two utility line routes based on latitude and longitude coordinates of the at least two utility line routes.

23. The computer system of claim 18, wherein the evaluator is configured to evaluate whether the utility line routes each pass through a common address.

24. The computer system of claim 18, wherein the evaluator is configured to evaluate whether the utility line routes each pass through at least one of a common floor, suite and room of a common address.

25. The computer system of claim 18, wherein the evaluator is configured to evaluate whether utility line routes both pass through a common geographical region.

26. The computer system of claim 18, wherein the evaluator is configured to evaluate whether utility line routes both pass through a common network equipment node.
